(19) United States
(12) Patent Application Publication
(10) Pub. No.: US 2008/0040576 A1
(43) Pub. Date: Feb. 14, 2008

(54) Associate Cached Branch Information with the Last Granularity of Branch instruction in Variable Length instruction Set

(76) Inventors: Brian Michael Stempel, Raleigh, NC (US); Rodney Wayne Smith, Raleigh, NC (US)

Correspondence Address: QUALCOMM INCORPORATED, 5775 MOREHOUSE DR., SAN DIEGO, CA, 92121, US

(21) Appl. No.: 11/463,370

(22) Filed: Aug. 9, 2006

(51) Int. Cl. G06F 9/30

(52) U.S. Cl. 712/204

(57) ABSTRACT

In a variable-length instruction set wherein the length of each instruction is a multiple of a minimum instruction length granularity, an indication of the last granularity (i.e., the end) of a taken branch instruction is a stored in a branch target address cache (BTAC). If a branch instruction that later hits in the BTAC is predicted taken, previously fetched instructions are flushed from the pipeline beginning immediately past the indicated end of the branch instruction. This technique saves BTAC space by avoiding to the need to store the length of the branch instruction in the BTAC, and improves performance by eliminating the necessity of calculating where to begin flushing (based on the length of the branch instruction).

### BACKGROUND

The present invention relates generally to the field of variable-length instruction set processors and in particular to a branch target address cache storing an indicator of the last granularity of a taken branch instruction.

Microprocessors perform computational tasks in a wide variety of applications. Improving processor performance is a sempiternal design goal, to drive product improvement by realizing faster operation and/or increased functionality through enhanced software. In many embedded applications, such as portable electronic devices, conserving power and reducing chip size are also important goals in processor design and implementation.

Most modern processors employ a pipelined architecture, where sequential instructions, each having multiple execution steps, are overlapped in execution. This ability to exploit parallelism among instructions in a sequential instruction stream contributes significantly to improved processor performance. Under ideal conditions and in a processor that completes each pipe stage in one cycle, following the brief initial process of filling the pipeline, an instruction may complete execution every cycle.

Such ideal conditions are never realized in practice, due to a variety of factors including data dependencies among instructions (data hazards), control dependencies such as branches (control hazards), processor resource allocation conflicts (structural hazards), interrupts, cache misses, and the like. A major goal of processor design is to avoid these hazards, and keep the pipeline “full.”

All real-world programs include branch instructions, which may comprise unconditional or conditional branch instructions. The actual branching behavior of branch instructions is often not known until the instruction is evaluated deep in the pipeline. This generates a control hazard that stalls the pipeline, as the processor does not know which instructions to fetch following the branch instruction, and will not know until the branch instruction evaluates. Most modern processors employ various forms of branch prediction, whereby the branching behavior of conditional branch instructions and branch target addresses are predicted early in the pipeline, and the processor speculatively fetches and executes instructions, based on the branch prediction, thus keeping the pipeline full. If the prediction is correct, performance is maximized and power consumption minimized. When the branch instruction is actually evaluated, if the branch was mispredicted, the speculatively fetched instructions must be flushed from the pipeline, and new instructions fetched from the correct branch target address. Mispredicted branches adversely impact processor performance and power consumption.

There are two components to a branch prediction: a condition evaluation and a branch target address. The condition evaluation (relevant only to conditional branch instructions) is a binary decision: the branch is either taken, causing execution to jump to a different code sequence, or not taken, in which case the processor executes the next sequential instruction following the conditional branch instruction. The branch target address (BTA) is the address to which control branches for either an unconditional branch instruction or a conditional branch instruction that evaluates as taken. Some branch instructions include the BTA in the instruction op-code, or include an offset whereby the BTA can be easily calculated. For other branch instructions, the BTA is not calculated until deep in the pipeline, and thus must be predicted.

One known technique of BTA prediction utilizes a Branch Target Address Cache (BTAC). A BTAC as known in the prior art is a cache that is indexed by a branch instruction address (BIA), with each data location (or cache “line”) containing a BTA. When a branch instruction evaluates in the pipeline as taken and its actual BTA is calculated, the BIA is written to a Content-Addressable Memory (CAM) structure in the BTAC and the BTA is written to an associated RAM location in the BTAC (e.g., during a write-back pipeline stage). When fetching new instructions, the CAM of the BTAC is accessed in parallel with an instruction cache. If the instruction address hits in the BTAC, the processor knows that the instruction is a branch instruction (prior to the instruction fetched from the instruction cache being decoded) and a predicted BTA is provided from the RAM of the BTAC, which is the actual BTA of the branch instruction's previous execution. If a branch prediction circuit predicts the branch to be taken, speculative instruction fetching begins at the predicted BTA. If the branch is predicted not taken, instruction fetching continues sequentially.

Note that the term BTAC is also used in the art to denote a cache that associates a saturation counter with a BIA, thus providing only a condition evaluation prediction (i.e., taken or not taken). That is not the meaning of this term as used herein.

High performance processors may fetch more than one instruction at a time from the instruction cache, in groups referred to herein as fetch groups. A fetch group may, but does not necessarily, correlate to an instruction cache line. A fetch group of, for example, four instructions, may be fetched into an instruction fetch buffer, which sequentially feeds them into the pipeline.

patent application Ser. No. 11/382,527, “Block-Based Branch Target Address Cache,” assigned to the assignee of the present application and incorporated herein by reference, discloses a block-based BTAC storing a plurality of entries, each entry associated with a block of instructions, where one or more of the instructions in the block is a branch instruction that has been evaluated taken. The BTAC entry includes an indicator of which instruction within the associated block is a taken branch instruction, and the BTA of the taken branch. The BTAC entries are indexed by the address bits common to all instructions in a block (i.e., by truncating the lower-order address bits that select an instruction within the block). Both the block size and the relative block borders are thus fixed.

patent application Ser. No. 11/422,186, “Sliding-Window, Block-Based Branch Target Address Cache,” assigned to the assignee of the present application and incorporated herein by reference, discloses a block-based BTAC in which each BTAC entry is associated with a fetch group, and is indexed by the address of the first instruction in the fetch group. Because fetch groups may be formed in different ways (e.g., beginning with the target of a branch), the group of instructions represented by each BTAC entry is not fixed. Each BTAC entry includes an indicator of which instruction within the fetch group is a taken branch instruction, and the BTA of the taken branch.

When a branch instruction hits in the BTAC and is predicted taken, sequential instructions following the branch instruction that have already been fetched (e.g., are part of the same fetch group) are flushed from the pipeline, and instructions beginning at the BTA retrieved from the BTAC are speculatively fetched into the pipeline following the branch instruction. As noted above, when the BTAC entries are associated with more than a single branch instruction, some indicator of which instruction within the block or group is the taken branch instruction is stored as part of each BTAC entry, so that instructions following the branch instruction may be flushed. For instruction sets wherein all instructions are the same length, storing an indicator of the beginning of the branch instruction is sufficient; instructions are flushed beginning at the next instruction address past that of the branch instruction.

For variable-length instruction sets, however, some indication of the length of the branch instruction itself must also be stored, so that the address of the first instruction following the branch instruction may be calculated. This both wastes storage space in the BTAC, and requires a calculation to determine where to begin flushing, which adversely impact performance by limiting the cycle time.

### SUMMARY

According to one or more embodiments, in a variable-length instruction set, an indication of the end of a taken branch instruction is stored in a branch target address cache (BTAC). As a non-limiting example, some versions of the ARM instruction set architecture include both 32-bit ARM mode branch instructions and 16-bit Thumb mode branch instructions. In this case, according to the present invention, an indication of the last halfword (e.g., 16 bits) of a taken branch instruction is stored in each BTAC entry. This corresponds to the branch instruction address (BIA) for a 16-bit branch instruction, and the last halfword for a 32-bit branch instruction. In either case, if a branch instruction that hits in the BTAC is predicted taken, previously fetched instructions may be flushed from the pipeline beginning immediately past the indicated halfword, without regard to the instruction length.

One embodiment relates to a method of executing instructions from a variable-length instruction set wherein the length of each instruction is a multiple of a minimum instruction length granularity. The branch target address of a branch instruction that evaluates taken is stored in a branch target address cache. An indicator of the address of the last granularity of the branch instruction is stored with the branch target address. Upon subsequently hitting in the branch target address cache, all instructions fetched past the last granularity of the hitting branch instruction are flushed.

Another embodiment relates to a processor executing instructions from a variable-length instruction set wherein the length of each instruction is a multiple of a minimum instruction length granularity. The processor includes an instruction cache storing a plurality of instructions, and a branch target address cache storing the branch target address and an indicator of the last granularity of a branch instruction that has previously evaluated taken. The processor also includes a branch prediction unit predicting whether a current branch instruction will evaluate taken or not taken and an instruction execution pipeline executing instructions. The processor further includes one or more control circuits operative to simultaneously access the instruction cache and the branch target address cache using a current instruction address and further operative to flush the pipeline of all instructions fetched after a branch instruction in response to a taken branch prediction and the indicator of the last granularity of a previously evaluated branch instruction.

Yet another embodiment relates to a branch target address cache comprising a plurality of entries, each entry indexed by a tag and a storing a branch target address and an indicator of the last granularity of a branch instruction that has previously evaluated taken.

### BRIEF DESCRIPTION OF DRAWINGS

FIG. 1 is a functional block diagram of a processor.

FIG. 2 is a functional block diagram of the fetch a stage of a processor.

FIG. 3 is a functional block diagram of a BTAC.

FIG. 4 depicts three processor instructions and a cycle diagram of register contents depicting the instructions' execution

### DETAILED DESCRIPTION

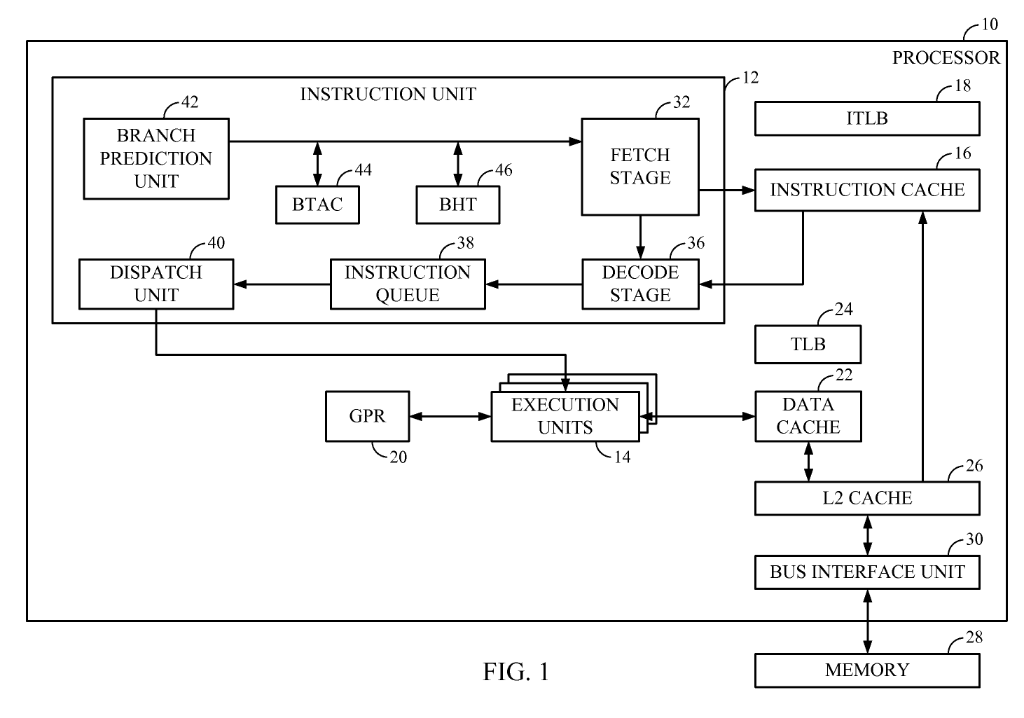

FIG. 1 depicts a functional block diagram of a processor 10. The processor 10 includes an instruction unit 12 and one or more execution units 14. The instruction unit 12 provides centralized control of instruction flow to the execution units 14. The instruction unit 12 fetches instructions from an instruction cache (instruction cache) 16, with memory address translation and permissions managed by an instruction-side Translation Lookaside Buffer (ITLB) 18.

The execution units 14 execute instructions dispatched by the instruction unit 12. The execution units 14 read and write General Purpose Registers (GPR) 20 and access data from a data cache 24, with memory address translation and permissions managed by a main Translation Lookaside Buffer (TLB) 24. In various embodiments, the ITLB 18 may comprise a copy of part of the TLB 24. Alternatively, the ITLB 18 and TLB 24 may be integrated. Similarly, in various embodiments of the processor 10, the instruction cache 16 and data cache 22 may be integrated, or unified. Misses in the instruction cache 16 and/or the data cache 22 cause an access to a second level, or L2 cache 26, depicted as a unified instruction and data cache 26 in FIG. 1, although other embodiments may include separate L2 caches. Misses in the L2 cache 26 cause an access to main (off-chip) memory 28, under the control of a memory interface 30.

The instruction unit 12 includes fetch 34 and decode 36 stages of the processor 10 pipeline. The fetch stage 32 performs instruction cache 16 accesses to retrieve instructions, which may include an L2 cache 26 and/or memory 28 access if the desired instructions are not resident in the instruction cache 16 or L2 cache 26, respectively. The decode stage 28 decodes retrieved instructions. The instruction unit 12 further includes an instruction queue 38 to store instructions decoded by the decode stage 28, and an instruction dispatch unit 40 to dispatch queued instructions to the appropriate execution units 14.

A branch prediction unit (BPU) 42 predicts the execution behavior of conditional branch instructions. Instruction addresses in the fetch stage 32 access a branch target address cache (BTAC) 44 and a branch history table (BHT) 46 in parallel with instruction fetches from the instruction cache 16. A hit in the BTAC 44 indicates a branch instruction that was previously evaluated taken, and the BTAC 44 provides the branch target address (BTA) of the branch instruction's last execution. The BHT 46 maintains branch prediction records corresponding to resolved branch instructions, the records indicating whether known branches have previously evaluated taken or not taken. The BHT 46 records may, for example, include saturation counters that provide weak to strong predictions that a branch will be taken or not taken, based on previous evaluations of the branch instruction. The BPU 42 assesses hit/miss information from the BTAC 44 and branch history information from the BHT 46 to formulate branch predictions.

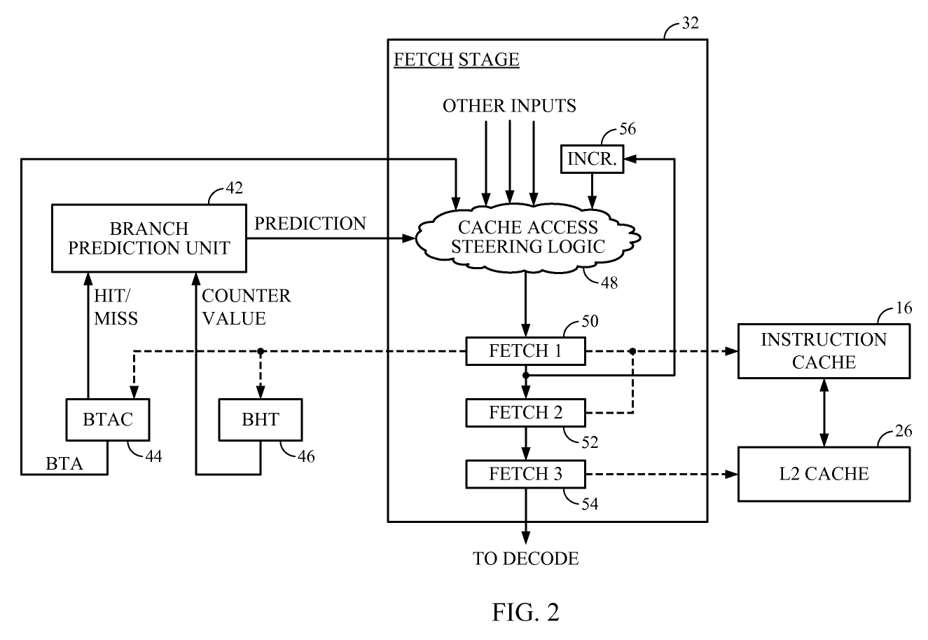

FIG. 2 is a functional block diagram depicting the fetch stage 32 and branch prediction circuits of the instruction unit 12 in greater detail. Note that the dotted lines in FIG. 2 depict functional access relationships, not necessarily direct connections. The fetch stage 32 includes cache accesses steering logic 48 that selects instruction addresses from a variety of sources. One instruction address per cycle is launched into the instruction fetch pipeline comprising, in this embodiment, three stages: the FETCH1 stage 50, the FETCH2 stage 52, and the FETCH3 stage 54.

The cache access steering logic 48 selects instruction addresses to launch into the fetch pipeline from a variety of sources. Two instruction address sources of particular relevance here include the next sequential instruction, instruction block, or instruction fetch group address, generated by an incrementor 56 operating on the output of the FETCH1 pipeline stage 50, and non-sequential branch target addresses speculatively fetched in response to branch predictions from the BPU 42. Other instruction address sources include exception handlers, interrupt vector addresses, and the like.

The FETCH1 stage 50 and FETCH2 stage 52 perform simultaneous, parallel, two-stage accesses to the instruction cache 16, the BTAC 44, and the BHT 46. In particular, an instruction address in the FETCH1 stage 50 accesses the instruction cache 16 and BTAC 44 during a first cache access cycle to ascertain whether instructions associated with the address are resident in the instruction cache 16 (via a hit or miss in the instruction cache 16) and whether a known branch instruction is associated with the instruction address (via a hit or miss in the BTAC 44). In the following, second cache access cycle, the instruction address moves to the FETCH2 stage 52, and instructions are available from the instruction cache 16 and/or a branch target address (BTA) is available from the BTAC 44, if the instruction address hit in the respective cache 16, 44.

If the instruction address misses in the instruction cache 16, it proceeds to the FETCH3 stage 54 to launch an L2 cache 26 access. Those of skill in the art will readily recognize that the fetch pipeline may comprise more or fewer register stages than the embodiment depicted in FIG. 2, depending on e.g., the access timing of the instruction cache 16 and BTAC 44.

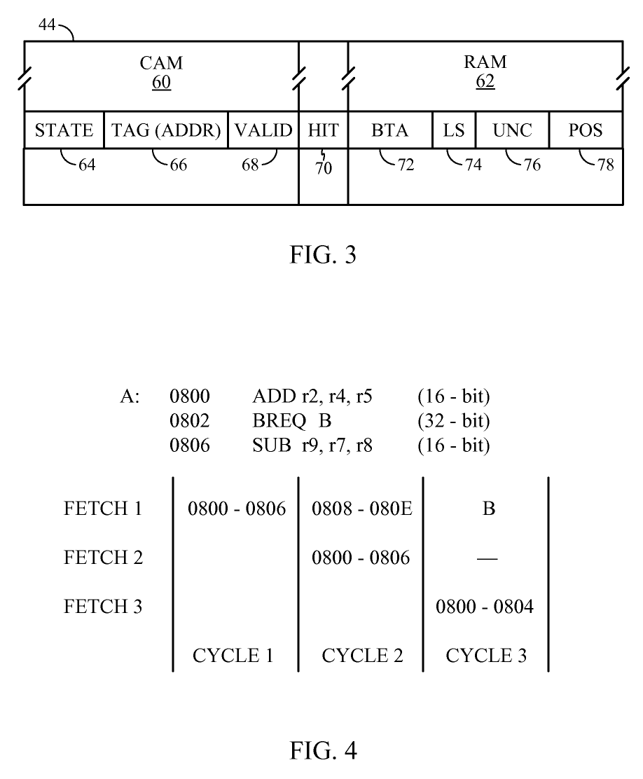

A functional block diagram of one embodiment of a BTAC 44 is depicted in FIG. 3. The BTAC 44 comprises a CAM structure 60 and a RAM structure 62. In a representative entry, the CAM structure 60 may include state information 64, an address tag 66, and a valid bit 68. As discussed above and in applications incorporated by reference, the tag 66 in one embodiment may comprise a single branch instruction address (BIA). In another embodiment, referred to herein as a block-based BTAC 44, the tag 66 may comprise the common address bits of a block or group of instructions (that is, with the least significant bits truncated). In another embodiment, referred to herein as a sliding-window BTAC 44, the tag 66 may comprise the address of the first instruction in an instruction fetch group.

However the BTAC 44 is structured, the tag 66 corresponds to a branch instruction that previously evaluated taken, and a hit—or a match between the address in the FETCH1 stage 54 and a tag 66—indicates that an instruction in the block or fetch group is a branch instruction. In response to a hit in the CAM 60, a corresponding hit bit 70 is set in the RAM structure 62 of the same BTAC 44 entry. In some embodiments, the hit bit 70 may comprise a non-clocked, monotonic storage device, such as a zero-catcher, one-catcher or jam latch. The details of cache design are not relevant to a description of the present invention, and are not discussed further herein.

During the second cache access cycle, data from the BTAC 44 entry identified by the hit bit 70 are read from the RAM structure 62. These data include the branch target address (BTA) 72, and may include additional information associated with the branch instruction, such a link stack bit 74 indicating whether the instruction is a link stack user, and/or an unconditional bit 76 indicating an unconditional branch instruction. Other data may be stored in the BTAC 44 RAM 62, as required or desired for any particular application.

Position bits 78, indicating the last granularity of the associated branch instruction, are also stored in the BTAC 44 entry. For a BTAC 44 wherein each tag 66 is associated with only one BIA, the position bits 78 identify the end of the branch instruction, such as by an offset from the BIA. In this case, the position bits 78 essentially identify the branch instruction length. For a block-based or a sliding-window BTAC 44—that is, if the tag 66 is associated with more than one instruction—the position bits 78 identify the position within the instruction block or fetch group of the last granularity of the taken branch instruction associated with the BTA 72. That is, the position bits 78 identify the position of the end of the branch instruction within the instruction block or fetch group.

FIG. 4 depicts an illustrative code snippet comprising three instructions, one of which is a 32-bit conditional branch instruction that previously evaluated taken. In this example, the fetch pipeline registers each hold four halfwords. FIG. 4 additionally depicts the instruction addresses in each of these registers as the instructions are fetched from the instruction cache 16. In the first cycle, the FETCH1 stage 50 holds instruction addresses 0800, 0802, 0804, and 0806. The address 0800 is applied to the instruction cache 16 and the BTAC 44 in the case of a sliding-window BTAC 44; in the case of a block-based BTAC 44, the two least significant bits are truncated prior to the BTAC 44 look-up. At the end of the first cycle, the BTAC 44 reports a hit, indicating that a branch instruction exists within the block or group, and that it previously evaluated taken. During the second cycle, the BTA (in this example, address B) and the position bits 78 are retrieved from the BTAC 44. Meanwhile, the addresses 0800-0806 drop into the FETCH2 stage 52, and the next sequential addresses 0808-080E are loaded into the FETCH1 stage 50 (via the incrementor 56).

In parallel to the instruction cache 16 and BTAC 44 look-ups, the BHT 46 is accessed, and provides past branch evaluation behavior for the associated branch instruction to the branch prediction unit (BPU) 42. Based on information retrieved from the BTAC 44 and BHT 46, the BPU 42 predicts whether the branch instruction associated with the current instruction address will evaluate taken or not taken. If the BPU 42 predicts the branch instruction will evaluate not taken, the sequential addresses (e.g., 0808-080E) flow through the fetch stage 32, resulting in instruction cache 16 and BTAC 44 accesses by 0808. On the other hand, if the BPU 42 predicts the branch instruction will evaluate taken, all instruction addresses following the branch instruction must be flushed from the fetch pipeline registers 50, 52, and the BTA retrieved from the BTAC 44 used instead for the next access of the instruction cache 16 and BTAC 44.

The position bits would conventionally indicate the position within the block or group of the beginning of the branch instruction, for example, 4′b0010 (assuming the addresses increment right-to-left in the registers). However, the beginning of the branch instruction is of use only to subsequently calculate the position where the instruction ends, which requires information regarding the instruction's length (for example, 16 or 32 bits). Furthermore, this calculation requires additional logic levels, which increase the cycle time and adversely impact performance. According to one or more embodiments disclosed herein, the position bits 78 indicate the last instruction length granularity of the branch instruction within the block or group. In the current example, the position bits 78 indicate the position within the block or group of the last halfword, for example, 4′b0100. This eliminates the need to store information regarding the branch instruction's length, and avoids a calculation to determine which instruction addresses to flush from the pipeline.

Returning to FIG. 4, in the third cycle (in response to a taken branch prediction from the BPU 42), the FETCH3 stage 54 contains instruction addresses 0800-0804. Address 0804 was identified as the end of the branch instruction by the value 4′b0100 of the position bits 78. The instruction of address 0806 is flushed from the FETCH3 stage 54, addresses 0808-080E are flushed from the FETCH2 stage 52, and the BTA of B, retrieved from the BTAC 44 in cycle 2, is loaded into the FETCH1 stage 50 to speculatively fetch instructions from that location.

As discussed above, the BHT 46 is accessed in parallel with the instruction cache 16 and BTAC 44. The BHT 46, in one embodiment, comprises an array of, e.g., two-bit saturation counters, each associated with a branch instruction. In one embodiment, a counter may be incremented every time a branch instruction evaluates taken, and decremented when the branch instruction evaluates not taken. The counter values then indicate both a prediction (by considering only the most significant bit) and a strength or confidence of the prediction, such as:

11—Strongly predicted taken

10—Weakly predicted taken

01—Weakly predicted not taken

00—Strongly predicted not taken

The BHT 46 may be indexed by part of the branch instruction address (BIA), e.g., the instruction address in the FETCH1 stage 50 when the BTAC 44 indicates a hit, identifying the instruction as a branch instruction that previously evaluated taken. To improve accuracy and make more efficient use of the BHT 46, the partial BIA may be logically combined with recent global branch evaluation history (gselect or gshare) prior to indexing the BHT 46.

One problem with BHT 46 design arises from variable-length instruction sets, wherein branch instructions may have different lengths. One known solution is to size the BHT 46 based on the largest instruction length, but address it based on the smallest instruction length. This solution leaves large pieces of the table empty, or with duplicate entries associated with longer branch instructions, when the addressing is based on the beginning of the branch instruction. By indexing the BHT 46 with information associated with the end of the branch instruction, BHT 46 efficiency is increased. Regardless of the length of the branch instruction, only a single BHT 46 entry is accessed.

As used herein, the granularity of a variable-length instruction set or a granule is the smallest amount by which instruction lengths may differ, which is typically also the minimum instruction length. Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of executing instructions from a variable-length instruction set wherein the length of each instruction is a multiple of a minimum instruction length granularity, comprising:
storing in a branch target address cache (BTAC) the branch target address (BTA) of a branch instruction that evaluated taken;
storing with the BTA, an indicator of the last granularity of the branch instruction; and
upon subsequently hitting in the BTAC, flushing all instructions fetched past the last granularity of the hitting branch instruction.

2. The method of claim 1 wherein the branch instruction was fetched in a fetch group, and wherein the BTAC entry containing the BTA is indexed by the address of the first instruction in the fetch group.

3. The method of claim 2 wherein the indicator of the last granularity of the branch instruction indicates the relative position of the end of the last granularity of the branch instruction within the fetch group.

4. The method of claim 1 wherein the branch instruction is associated with a block of instructions, and wherein the BTAC entry containing the BTA is indexed by the common address bits of all instructions in the block.

5. The method of claim 4 wherein the indicator of the last granularity of the branch instruction indicates the relative position of the end of the last granularity of the branch instruction within the block of instructions.

6. The method of claim 1 further comprising upon subsequently hitting in the BTAC, accessing a branch history table (BHT) based at least in part on the indicator of the last granularity of the hitting branch instruction.

7. The method of claim 1 further comprising, after flushing all instructions fetched past the last granularity of the hitting branch instruction, fetching instructions beginning with the BTA.

8. A processor executing instructions from a variable-length instruction set wherein the length of each instruction is a multiple of a minimum instruction length granularity, comprising:
an instruction cache storing a plurality of instructions;
a branch target address cache (BTAC) storing the branch target address (BTA) and an indicator of the last granularity of a branch instruction that has previously evaluated taken;
a branch prediction unit (BPU) predicting whether a current branch instruction will evaluate taken or not taken;
an instruction execution pipeline executing instructions;
one or more control circuits operative to simultaneously access the instruction cache and the BTAC using a current instruction address; and further operative to flush the pipeline of all instructions fetched after a branch instruction in response to a taken branch prediction and the indicator of the last granularity of a previously evaluated branch instruction.

9. The processor of claim 8 wherein the BTAC is a sliding-window BTAC indexed by the address of the first instruction in a fetch group that includes a branch instruction that has previously evaluated taken.

10. The processor of claim 9 wherein the indicator of the last granularity of the branch instruction that has previously evaluated taken indicates the relative position of the last granularity of the branch instruction within the fetch group.

11. The processor of claim 8 wherein the BTAC is a block-based BTAC indexed by the common address bits of all instructions in a block of instructions that includes a branch instruction that has previously evaluated taken.

12. The processor of claim 11 wherein the indicator of the last granularity of the branch instruction that has previously evaluated taken indicates the relative position of the last granularity of the branch instruction within the block of instructions.

13. The processor of claim 8 further comprising a branch history table (BHT) storing prior branch evaluation information, the BHT indexed at least in part by the indicator of the last granularity of the branch instruction that has previously evaluated taken.

14. The processor of claim 13 wherein the branch prediction is based at least in part on the output of the BHT.

15. A branch target address cache (BTAC) comprising a plurality of entries, each entry indexed by a tag and a storing a branch target address (BTA) and an indicator of the last granularity of a branch instruction that has previously evaluated taken.

16. The BTAC of claim 15 wherein the tag comprises the address of the first instruction in a fetch group that includes a branch instruction that has previously evaluated taken.

17. The BTAC of claim 16 wherein the indicator of the last granularity of the branch instruction that has previously evaluated taken indicates the relative position of the last granularity of the branch instruction within the fetch group.

18. The BTAC of claim 15 wherein the tag comprises the common address bits of instructions in a block of instructions that includes a branch instruction that has previously evaluated taken.

19. The BTAC of claim 18 wherein the indicator of the last granularity of the branch instruction that has previously evaluated taken indicates the relative position of the last granularity of the branch instruction within the block of instructions.
